(19) United States
(12) Patent Application Publication
(10) Pub. No.: US 2008/0249682 A1
(43) Pub. Date: Oct. 9, 2008

(54) Touch control bezel for display devices

(75) Inventors: Dean Thomas Wisniewski, Detroit, MI (US); John Thomas Kosinski, River Rouge, MI (US)

Correspondence Address: VISTEON/BRINKS HOFER GILSON & LIONE, 524 South Main Street, Suite 200, Ann Arbor, MI, 48104, US

(73) Assignee: Visteon Global Technologies, Inc.

(21) Appl. No.: 11/784,555

(22) Filed: Apr. 6, 2007

(51) Int. Cl. B60R 16/02

(52) U.S. Cl. 701/36

(57) ABSTRACT

A machine interface system for use in a motor vehicle includes a bezel having a display opening and at least one active surface adjacent the display opening. At least one sensor assembly is associated with the active surface and generates a sensor signal corresponding to a location on the active surface touched by a vehicle occupant. A reconfigurable display is disposed within the display opening and is configured to display, adjacent to the active surface, at least one image associated with a vehicle function. Coupled to the sensor assembly is a controller that is configured to generate the image and to receive the sensor signal. The controller responds to the sensor signal according to the vehicle function associated with the image when the corresponding active surface is touched by the occupant.

### BACKGROUND OF THE INVENTION

1. Field of the Invention

The present invention generally relates to human machine interfaces. More specifically, the invention relates to a touch control system for a display device in a motor vehicle.

2. Description of Related Art

Motor vehicles generally have various devices with displays to provide information to an occupant and access to features. Some examples of such devices include automotive radios, automotive navigation systems, and vehicle information systems.

One way for an occupant to interact with these devices is via an active touch screen display. A touch screen display allows the occupant to select information or functions by touching an area of the display. Touch screen displays have the advantage that they can be reconfigured in a large number of ways and may be upgraded with additional features without changing the display hardware. In addition, they allow multiple devices to be consolidated into a single unit, for example, both the automotive radio and navigation system may be accessed through a single touch screen. However, active touch screens are more costly since the must incorporate both a display and a touch sensitive layer. Additionally, the display of the screen cannot be easily upgraded independently of touch layer. Also, touch screens often have reduced image quality, either initially or caused by use, compared to other displays, and they may occupy more space.

Another way the occupant may interact with the above devices is by pushing physical buttons/keys or turning knobs associated with a non-touch display. This configuration has the advantage that the display may be easily upgraded independently of the button/keys or knobs and has a lower initial cost. On the other hand, the buttons/keys or knobs are physically fixed, limiting the types of functions to which they may be assigned, what may be displayed, and how they may be configured. As a result, upgrades or changes are not possible without hardware changes. The buttons/keys and knobs are also clearly visible to the occupant, limiting styling options. Also, as more features are added, more buttons/keys or knobs are added, limiting the available display area.

In view of the above, it is apparent that there exists a need for an improved display interface.

### SUMMARY OF THE INVENTION

In satisfying the above need, as well as overcoming the enumerated drawbacks and other limitations of the related art, the present invention provides a reconfigurable machine interface system for use in a motor vehicle. The system includes a bezel defining a display opening and includes at least one active surface defined adjacent the display opening. A sensor assembly is located in proximity to, and is associated with, the active surface. The sensor assembly generates a sensor signal corresponding to a location on the active surface when the active surface is touched by the occupant. A reconfigurable display is located within the display opening and is configured to display an image associated with a vehicle function, adjacent to the active surface. Coupled to the sensor assembly and the display is a controller, which is configured to generate the image and to receive the sensor signal. The controller is further configured to respond to the sensor signal, according to the vehicle function associated with the image, when the corresponding active surface is touched by the vehicle occupant.

In some embodiments, the active surface is integral with the bezel. In other embodiments, the active surface is configured to be substantially stationary with respect to the bezel when touched by the vehicle occupant. The display opening of the bezel may be rectangular. In a first example, a first active surface and a first sensor assembly are located along a first side of the rectangular display opening. In a second example, a second active surface and a second sensor assembly are located along a second side of the opening. In a third and fourth example, a third and fourth active surface and a third and fourth sensor assembly are located along a third and fourth side of the opening, respectively.

In still other embodiments, the rectangular display opening defines four corners with an active surface, which may be at least one of a switch, potentiometer, and a data port, located adjacent or in at least one of the corners. The switch may be, for example, a soft key push button. The potentiometer may be, for example, a rotary potentiometer, and the data port may be, for example, a standard universal serial bus port.

In various embodiments, the display may include at least one of a reconfigurable light emitting diode display panel, a liquid crystal display panel, an organic light-emitting diode display panel, a plasma display panel, a field emitter display panel, a surface-conduction electron-emitter display panel, and an electrochromic display panel. The display may be stationary in the motor vehicle or it may be movable.

In yet other embodiments, the sensor assembly may include at least one of a resistive touch element, a capacitive touch element, a field-effect touch element, a thermal touch element, and an optical touch element. In various examples, the sensor assembly is configured to output either a discrete signal, a proportional signal, or a combination of discrete and proportional signals.

In another embodiment, feedback may be provided to the occupant that the controller has responded to the sensor signal corresponding to the active surface touched by the occupant. For example, the feedback may include audio feedback, visual feedback, haptic feedback, or a combination thereof.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic front view of one embodiment of the present invention displaying a first mode; and

FIG. 2 is the schematic front view of the embodiment of FIG. 1 displaying a second mode.

### DETAILED DESCRIPTION

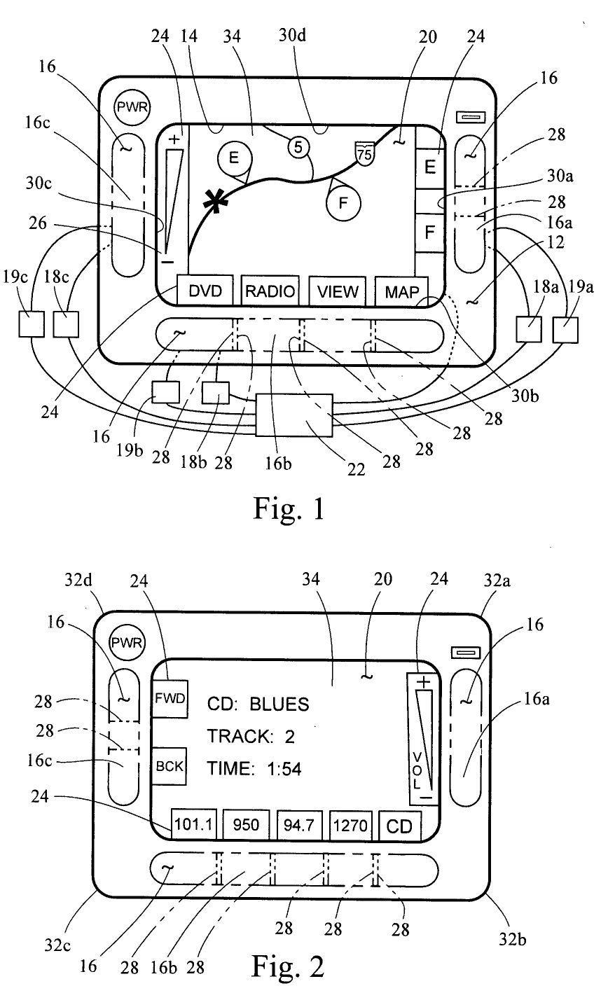

Referring now to FIGS. 1 and 2, a reconfigurable human-machine interface system embodying the principles of the present invention is illustrated therein and designated at 10. As its primary components, the system 10 includes a bezel 12, at least one sensor assembly 18, a reconfigurable display 20, and a controller 22. The bezel 12 has portions defining a display opening 14 and at least one active surface 16, which is/are demarcated by phantom lines in the figures. The display 20, disposed within the display opening 14, is configured to display images 24 adjacent to the active surfaces 16. The images 24 may, for example, be associated with various motor vehicle functions.

The at least one sensor assembly 18 is located in proximity to, and is associated with an active surface 16. The examples of FIGS. 1 and 2 show three sensor assemblies 18a, 18b, and 18c respectively associated with three active surfaces 16a, 16b, and 16c. However, in other examples varying quantities of sensor assemblies 18 and active surfaces 16 may be provided depending on the needs of a particular application. The sensor assemblies 18 are configured to generate at least one sensor signal corresponding to a location on the active surfaces 16 that have been touched by, for example, an occupant of the motor vehicle. This sensor signal may be either discrete or proportional.

The controller 22 is coupled to the sensor assembly 18 and the display 20 and is configured to generate the images 24 displayed adjacent to the active surfaces 16. The controller 22 is also configured to receive the sensor signal. As indicated above, the sensor signal indicates the location on the active surface 16 touched by the occupant. The controller 22 responds to the sensor signal by comparing the location touched on the active surface 16 to the location of the images 24 displayed on the display 20. The controller 22 then responds according to the vehicle function that is associated with the image 24 that is adjacent to the location touched by the occupant.

The above function is best illustrated beginning with the example of FIG. 1 which shows a vehicle navigation system displaying a road map. If an occupant touches the active surface 16a (a first active surface) adjacent the letter “F” on the display, for example, the controller 22 may display more information (not shown) regarding the area “F” on the display 20. If, for example, the occupant touches another active surface 16b (a second active surface) adjacent the word “RADIO” on the display assembly, the controller may change modes and display radio controls as shown in FIG. 2. While these are examples of the controller 22 responding to discrete signals from the sensor assembly 18, a proportional signal can be generated by the occupant sliding a finger along another active surface 16c (a third active surface) adjacent to zoom controls 26, for example, on the display assembly 20 seen in FIG. 1. In this example, the proportional signal might cause the view of the map to zoom in when the occupant slides their finger up along the third active surface 16c and zoom out when they slide their finger down along the surface.

It should be understood that the sensor assemblies 18 may generate a signal wherever the occupant touches the active surface 16. Thus, in a preferred embodiment the active surface 16 is a continuous surface and is not divided into separate physical segments. For the purpose of illustration only, dividing lines 28 have been included to help demarcate boundaries between active locations within the active surface 16. The dividing lines 28, illustrated here with phantom lines, merely show one non-limiting example of where the controller 22 considers one location next to an image 24 to end and another location next to another image 24 to begin.

As best shown in FIG. 2, when the mode of the system 10 changes, the number and position of the logical dividing lines 28 within each of the active surfaces 16 may remain the same, increase, decrease or be omitted entirely. In this illustrated example, when the system 10 changes from navigation mode to radio mode, the active locations of the first active surface 16a are changed. In FIG. 1, the first active surface 16a was used to generate two discrete signals to select navigation functions. In FIG. 2 the surface 16a is used to generate a proportional signal to, for example, increase or decrease a volume of the radio. In addition, the second active surface 16b has been changed from generating four discrete signals to generating five discrete signals. Likewise, the third active surface 16c has been changed from generating a proportional signal in FIG. 1, to generating two discrete signals in FIG. 2. It is also possible for the active surfaces 16 to generate a combination of discrete and proportional signals (not shown). This is all accomplished internally by the controller 22, without any physical changes between modes to the sensor signal or hardware. As one skilled in the art will readily appreciate, many different combinations of control arrangements may be provided according to the present invention depending on the needs and geometry of a particular application and such changes are within the scope of this invention.

It should be noted that in some instances the bezel 12 and display 20 may be stationary. However, in other instances the bezel 12 and/or display 20 may be articulated to move within the motor vehicle. For example, the display 20 may retract during radio mode such that only a portion of the entire display 20 is fully exposed during navigation mode. Likewise, it may be desirable in other instances to rotate the display 20 and/or the bezel 12 between a portrait orientation and a landscape orientation. Regardless of how the display 20 and bezel 12 move during operation, the controller 22 reconfigures the active surfaces 16 to provide an appropriate interface.

In some possible implementations of the present invention, the active surface 16 may be integrally formed with the bezel 12. In these implementations, the active surface 16 cannot be visually distinguished from the rest of the bezel 12. Rather, depending on the type of sensor assembly 18 used, the sensor assembly 18 may, for example, be attached behind an outer surface of the bezel 12 and configured to provide the sensor signal when the occupant touches the outer surface.

The active surface 16 need only be touched lightly to generate the signal. Depending on the sensor assembly 18, it should not be necessary for the occupant to deflect the portion of the bezel 12 having the active surface 16 to generate the signal. In other words, the active surface 16 should remain substantially stationary with respect to the rest of the bezel 12 when touched by the vehicle occupant.

In some optional examples, the active surface 16 or sensor assemblies 18 may be configured to provide feedback to the occupant. In another example, separate feedback devices 19a-19c may be provided as shown in FIG. 1. The feedback lets the occupant know the controller 22 received a signal when the occupant touched the active surface 16. In addition, the feedback also provides an indication to the occupant that a vehicle function was activated. The feedback may include, but is not limited to, audio, visual or haptic (i.e. physical) feedback. Examples of audio and visual feedback respectively include, but are not limited to, a tone from a speaker or highlighting the function on the display 20. Examples of haptic feedback include, but are not limited to, a buzz, vibration or other tactile feedback.

In other implementations, the display opening 14 of the bezel 12 includes, but is not limited to, a rectangular display opening, as shown in FIGS. 1 and 2. In still other implementations, it may be desirable for the display opening 14 to have other shapes including, for example, circular or triangular openings, depending on the needs of a particular application. In the example shown, the first active surface 16a is located along a first side 30a of the display opening 14. The second active surface 16b is located along a second side 30b, and the third active surface 16c is located along a third side 30c. In another variant on the invention, a fourth active surface (not shown) may be located along a fourth side 30d of the display opening 14. In still another variant, a compact disc or other media slot may be located along any of the sides 30a-30d.

The rectangular embodiment of FIG. 2 defines four corners 32a-32d. As such, the present invention also allows other desirable controls to be located in the bezel 12 adjacent the corners of the display opening 14. These controls may include, but are not limited to, a switch, a potentiometer, and a data port. In one possible implementation, the switch may include a soft key push button to activate or deactivate the system 10. Alternatively, or in addition, a potentiometer (such as a rotary potentiometer) and a data port (such as a standard universal serial bus port) may be included.

Looking more closely at the display 20, it incorporates a reconfigurable flat panel display 34. The flat panel display 34 may be of any type capable of fitting within the display opening 14, with typical examples including, but not limited to, light emitting diode (LED) displays, liquid crystal displays (LCD), organic light-emitting diode (OLED) displays, plasma displays, field emitter displays (FED), surface-conduction electron-emitter displays (SED), and electrochromic displays.

In some embodiments, such as the LCD's shown in FIGS. 1 and 2, the flat panel display 34 may also require backlights (not shown). The backlights may be any type known in the art capable of meeting the illumination needs of the particular flat panel display 34. Such back lighting typically includes light-emitting diodes (LED's) or fluorescent bulbs. In either case, the purpose of the backlights is to illuminate the flat panel display 34 from behind and determine the brightness of the displayed image. On the other hand, for example, an OLED flat panel display 34 is self-illuminating and does not require any backlights.

Looking more closely at the sensor assembly 18, it incorporates any of a variety of sensor elements known in the art. The sensor elements may be of any type capable of being associated with the bezel 12 and reading a touched location of the bezel 12. While most embodiments of the sensor assembly 18 are anticipated as being directly attached to the bezel 12 behind the active surface 16, other embodiments, such as optical monitoring elements, may not be directly attached to the bezel 12. Typical examples of the sensor elements include, but are not limited to, resistive touch elements, capacitive touch elements, field-effect touch elements, thermal touch elements, and optical monitoring elements.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. A reconfigurable machine interface system for use by an occupant of a motor vehicle, the system comprising:
a bezel having portions defining a display opening and including at least one active surface defined adjacent the display opening;
at least one sensor assembly being located in proximity to and being associated with the active surface, the sensor assembly being configured to generate a sensor signal corresponding to a location on the active surface when the active surface is touched by the occupant at that location;
a reconfigurable display disposed within the display opening, the display being configured to display at least one image associated with at least one vehicle function adjacent to the active surface; and
a controller coupled to the sensor assembly and the display, the controller configured to generate the image and to receive the sensor signal, the controller further configured to respond to the sensor signal according to the vehicle function associated with the image when the corresponding active surface is touched by the vehicle occupant.

2. The machine interface system according to claim 1 wherein the active surface is integral with the bezel.

3. The machine interface system according to claim 1 wherein the active surface is configured to be substantially stationary with respect to the bezel when touched by the vehicle occupant.

4. The machine interface system according to claim 1 wherein the display opening of the bezel is a rectangular display opening.

5. The machine interface system according to claim 4 wherein the active surface includes a first active surface and a first sensor assembly, the first active surface and the first sensor assembly being located along a first side of the rectangular display opening.

6. The machine interface system according to claim 5 further comprising a second active surface and a second sensor assembly, the second active surface and the second sensor assembly being located along a second side of the rectangular display opening.

7. The machine interface system according to claim 6 further comprising a third active surface and a third sensor assembly, the second active surface and the second sensor assembly being located along a third side of the rectangular display opening.

8. The machine interface system according to claim 7 further comprising a fourth active surface and a fourth sensor assembly, the fourth active surface and the fourth sensor assembly being located along a fourth side of the rectangular display opening.

9. The machine interface system according to claim 1 wherein the display opening defines at least one corner and a switch is disposed in the bezel adjacent to the at least one corner.

10. The machine interface system according to claim 9 wherein the switch is a soft key push button.

11. The machine interface system according to claim 1 wherein the display opening defines at least one corner and a potentiometer is disposed in the bezel adjacent to the at least one corner.

12. The machine interface system according to claim 11 wherein the potentiometer is a rotary potentiometer.

13. The machine interface system according to claim 1 wherein the display opening defines at least one corner and a data port is disposed in the bezel adjacent to the at least one corner.

14. The machine interface system according to claim 13 wherein the data port is a universal serial bus port.

15. The machine interface system according to claim 1 wherein the display includes at least one of a reconfigurable light emitting diode display panel, a liquid crystal display panel, an organic light-emitting diode display panel, a plasma display panel, a field emitter display panel, a surface-conduction electron-emitter display panel, and an electrochromic display panel.

16. The machine interface system according to claim 1 wherein the at least one sensor assembly includes at least one of a resistive touch element, a capacitive touch element, a field-effect touch element, a thermal touch element, and an optical monitoring element.

17. The machine interface system according to claim 1 wherein the at least one sensor assembly is configured to generate both a discrete signal and a proportional signal.

18. The machine interface system according to claim 1 further comprising a feedback device coupled to the controller and configured to provide feedback to the occupant that the controller has responded to the sensor signal.

19. The machine interface system according to claim 18 wherein the feedback device is configured to provide haptic feedback.

20. The machine interface system according to claim 18 wherein the feedback device is configured to provide at least one of audio feedback, visual feedback and combinations thereof.
